(19) United States
(12) Patent Application Publication
(10) Pub. No.: US 2009/0129634 A1
(43) Pub. Date: May 21, 2009

(54) IMAGE PROCESSING METHOD

(75) Inventor: Stijn De Waele, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,827

(22) PCT Filed: Oct. 25, 2005
(86) PCT No.: PCT/IB05/53491

§ 371 Date: Apr. 24, 2007

(30) Foreign Application Priority Data
Oct. 27, 2004 (EP) 04300738.4

(51) Int. Cl. G06K 9/00

(52) U.S. Cl. 382/107

(57) ABSTRACT

A set of images (IM 1 a, IM2a, IMFa) that have successively been captured comprises a plurality of images (IM 1 a, IM2a) that have been captured under substantially similar light conditions, and an image (IMFa) that has been captured under substantially different light conditions (FLSH). For example, two images may be captured with ambient light and one with flashlight. A motion indication (MV) is derived (ST6) from at least two images (IM 1a, IM2a) that have been captured under substantially similar light conditions. The image (IMFa) that has been captured under substantially different light conditions is processed (ST7, ST8) on the basis of the motion indication (MV) derived from the at least two images (IM1 a, IM2a) that have been captured under substantially similar light conditions.

### FIELD OF THE INVENTION

An aspect of the invention relates to a method of processing a set of images that have been successively captured. The method may be applied in, for example, digital photography so as to subjectively improve an image that has been captured with flashlight. Other aspects of the invention relate to an image processor, an image-capturing apparatus, and a computer-program product for an image processor.

### DESCRIPTION OF PRIOR ART

The article entitled “Flash Photography Enhancement via Intrinsic Relighting” by Elmar Eisemann et al., Siggraph 2004, Los Angeles, USA, Aug. 8-12, 2004, Volume 23, Issue 3, pages: 673-678, describes a method of enhancing photographs shot in dark environments. A picture taken with the available light is combined with one taken with a flash. A bilateral filter decomposes the pictures into detail and large scale. An image is reconstructed using the large scale of the picture taken with the available light, on the one hand, and the detail of the picture taken with the flash, on the other hand. Accordingly, the ambience of the original lighting is combined with the sharpness of the flash image. It is mentioned that advanced approaches could be used to compensate for subject motion.

### SUMMARY OF THE INVENTION

According to an aspect of the invention, a set of images that have been successively captured comprises a plurality of images that have been captured under substantially similar light conditions, and an image that has been captured under substantially different light conditions. A motion indication is derived from at least two images that have been captured under substantially similar light conditions. The image that has been captured under substantially different light conditions is processed on the basis of the motion indication derived from the at least two images that have been captured under substantially similar light conditions.

The invention takes the following aspects into consideration. When an image is captured with a camera, one or more objects that form part of the image may move with respect to the camera. For example, an object that forms part of the image may move with respect to another object that also forms part of the image. The camera can track one of those objects only. All objects that form part of the image will generally move if the person holding the camera has a shaky hand.

An image may be processed in a manner that takes into account respective motions of objects that form part of the image. Such motion-based processing may enhance image quality as perceived by human beings. For example, it can be prevented that one or more moving objects cause the image to be blurred. Motion can be compensated when a combination is made of two or more images captured at different instants. Motion-based processing may further be used to encode the image so that a relatively small amount of data can represent the image with satisfactory quality. Motion-based image processing generally requires some form of motion estimation, which provides indications of respective motions in various parts of the image.

Motion estimation may be carried out in the following manner. The image of interest is compared with a so-called reference image, which has been captured at a different instant, for example, just before or just after the image of interest has been captured. The image of interest is divided into several blocks of pixels. For each block of pixels, a block of pixels in the reference image is searched that best matches the block of pixels of interest. In case of motion, there will be a relative displacement between the two aforementioned blocks of pixels. The relative displacement provides a motion indication for the block of pixels of interest. Accordingly, a motion indication can be established for each block of pixels in the image of interest. The respective motion indications constitute a motion indication for the image as a whole. Such motion estimation is commonly referred to as block-matching motion estimation. Video encoding in accordance with a Moving Pictures Expert Group (MPEG) standard typically uses block-matching motion estimation.

Block-matching motion estimation will generally be unreliable when the image of interest and the reference image have been captured under different light conditions. This may be the case, for example, if the image of interest has been captured with ambient light whereas the reference image has been captured with flashlight, or vice versa. Block-matching motion estimation takes luminance into account when searching for the best match between a block of pixels in the image of interest and a block of pixels in the reference image. Consequently, block-matching motion estimation may find that, in the image of interest, a block of pixels, which has a given luminance, best matches a block of pixels that has similar luminance in the reference image. However, the respective block of pixels may belong to different objects.

For example, let it be assumed that a first image is captured with ambient light and a second image is captured with flashlight. In the first image, there is an object X that appears to be light gray and another object Y that appears to be dark gray. In the second image, which is captured with flashlight, the object X may appear to be white and the object Y may appear to be light gray. There is a serious risk that a block-matching motion estimation finds that a light-gray block of pixels in the first image, which belongs to object X, best matches with a similar light-gray block of pixels in the second image, which belongs to object Y. The block-matching motion estimation will thus produce a motion indication that relates to the location of object X in the first image with respect to the location of object Y in the second image. The block-matching motion estimation has thus confused objects. The motion indication is wrong.

It is possible to apply a different motion estimation technique, which is less sensitive to differences in light conditions under which respective images have been captured. For example, the motion estimation operation may be arranged so that luminance or brightness information is ignored. Color information is taken into account only. Nevertheless, such color-based motion estimation does generally not provide sufficiently precise motion indications. The reason for this is that color comprises less detail than luminance. Another possibility is to base motion estimation on edge information. A high pass filter can extract edge information from an image. Variations in pixel values are considered rather than the pixel values themselves. Even such edge-based motion estimation provides relatively imprecise motion indications in quite a number of cases. The reason for this is that edge information is generally affected too when light conditions change. In general, any motion estimation technique is to a certain extent sensitive to different light conditions, which may lead to erroneous motion indications.

In accordance with the aforementioned aspect of the invention, a motion indication is derived from at least two images that have been captured under substantially similar light conditions. An image that has been captured under substantially different light conditions is then processed on the basis of the motion indication derived from the at least two images that have been captured under substantially similar light conditions.

The motion indication is relatively precise with respect to the at least two images that have been captured under substantially similar light conditions. This is because motion estimation has not been disturbed by differences in light conditions. However, the motion indication derived from the at least two images that have been captured under substantially similar light conditions does not directly relate to the image that has been captured under substantially different light conditions. This is because the latter image has not been taken into account in the process of motion estimation. This may introduce some imprecision. In fact, it is assumed that motion is substantially continuous throughout an interval of time during which the images are captured. In general, this assumption is sufficiently correct in a great number of cases, so that any imprecision will generally be relatively modest. This is particularly true compared with imprecision due to differences in light conditions, as explained hereinbefore. Consequently, the invention allows a more precise indication of motion in an image that has been captured under substantially different light conditions. As a result, the invention allows relatively good image quality.

The invention may advantageously be applied in, for example, digital photography. A digital camera may be programmed to capture at least two images with ambient light in association with an image captured with flashlight. The digital camera derives a motion indication from the at least two images captured with ambient light. The digital camera can use this motion indication to make a high-quality combination of the image captured with flashlight and at least one of the two images captured with ambient light.

Another advantage of the invention relates to the following aspects. In accordance with the invention, the motion indication for an image that has been captured under substantially different light conditions need not be derived from that image itself. The invention therefore does not require a motion estimation technique that is relatively insensitive to differences in light conditions. Such motion estimation techniques, which have been described hereinbefore, generally require complicated hardware or software, or both. The invention allows satisfactory results with a relatively simple motion estimation technique, such as, for example, a block-matching motion estimation technique. Already existing hardware and software can be used, which is cost-efficient. For those reasons, the invention allows cost-efficient implementations.

These and other aspects of the invention will be described in greater detail hereinafter with reference to drawings.

### BRIEF DESCRIPTION OF THE DRAWINGS

FIG. 1 is a block diagram that illustrates a digital camera.

FIGS. 2A and 2B are flow-chart diagrams that illustrate operations that the digital camera carries out.

FIGS. 3A, 3B, and 3C are pictorial diagrams illustrating three successive images that the digital camera captures.

FIGS. 4A and 4B are flow-chart diagrams illustrating alternative operations that the digital camera may carry out.

FIG. 5 illustrates an image processing apparatus.

### DETAILED DESCRIPTION

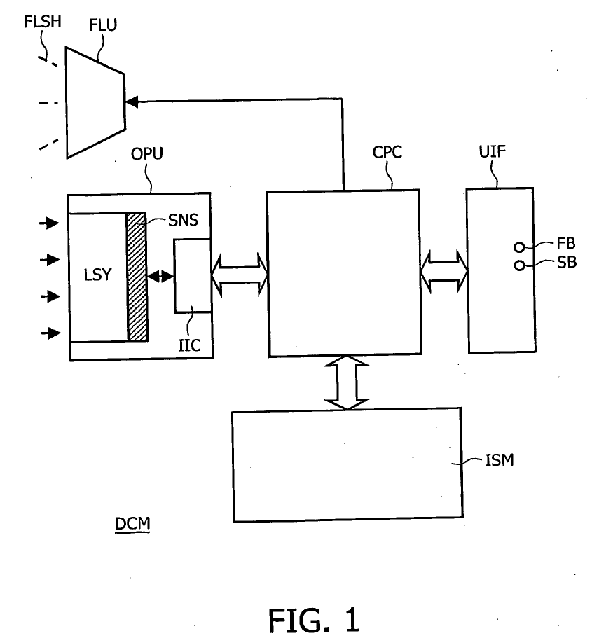

FIG. 1 illustrates a digital camera DCM. The digital camera DCM comprises an optical pickup unit OPU, a flash unit FLU, a control-and-processing circuit CPC, a user interface UIF, and an image storage medium ISM. The optical pickup unit OPU comprises a lens-and-shutter system LSY, an image sensor SNS and an image interface-circuit IIC. The user interface UIF comprises an image-shot button SB and a flash button FB and may further comprise a mini display device that can display an image. The image sensor SNS may be in the form of, for example, a charged coupled device or a compatible metal oxide semiconductor (CMOS) circuit. The control-and-processing circuit CPC, which may be in the form of, for example, a suitably programmed circuit, will typically comprise a program memory that comprises instructions, i.e. software, and one or more processing-units that execute these instructions, which causes data to be modified or transferred, or both. The image storage medium ISM may be in the form of, for example, a removable memory device such as compact flash.

The optical pickup unit OPU captures an image in a substantially conventional manner. A shutter, which forms part of the lens-and-shutter system LSY, opens for a relatively short interval of time. The image sensor SNS receives optical information during that interval of time. Lenses, which form part of the lens-and-shutter system LSY, project the optical information on the image sensor SNS in a suitable manner. Focus and aperture are parameters that define lens settings. The optical sensor converts the optical information into analog electrical information. The image interface-circuit IIC converts the analog electrical information into digital electrical information. Accordingly, a digital image is obtained which represents the optical information as a set of digital values. This is the image captured.

The flash unit FLU may provide flashlight FLSH illuminating objects that are relatively close to the digital camera DCM. Such objects will reflect a portion of the flashlight FLSH. A reflected portion of the flashlight FLSH will contribute to the optical information that reaches the optical sensor. Consequently, the flashlight FLSH may enhance the luminosity of objects that are relatively close to the digital camera DCM. However, the flashlight FLSH may cause optical effects that appear unnatural, such as, for example, red eyes, and may also cause the image to have a flat and harsh appearance. An image of a scene that has been captured with sufficient ambient light is generally considered more pleasant than an image of the same scene captured with flashlight. However, an ambient-light image may be noisy and blurred if there is insufficient ambient light, in which case a flashlight image is generally preferred.

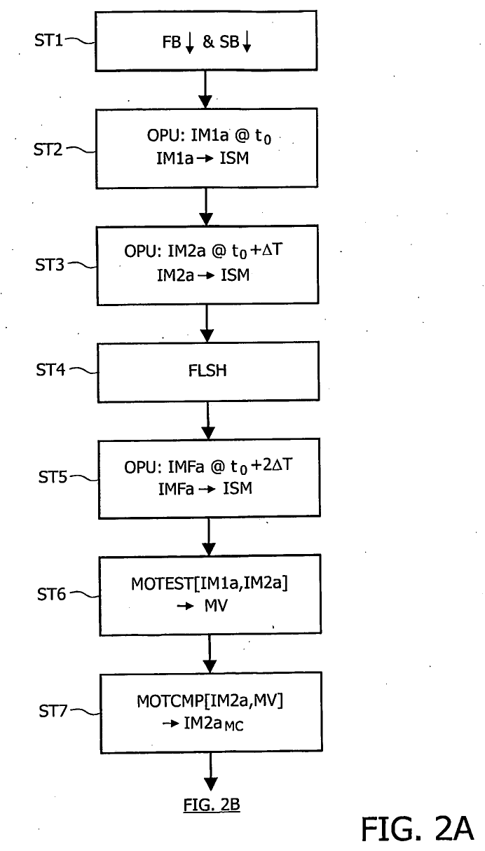

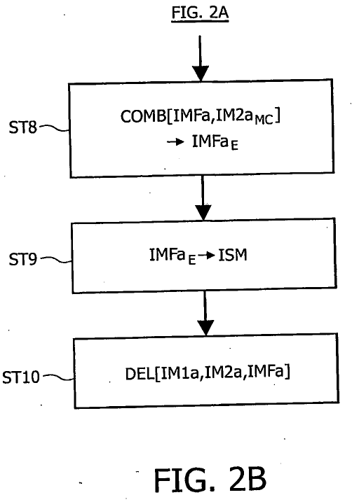

FIGS. 2A and 2B illustrate operations that the digital camera DCM carries out. The operations are illustrated in the form of a series of steps ST1-ST10. FIG. 2A illustrates steps ST1-ST7 and FIG. 2B illustrates steps ST8-ST10. The illustrated operations are typically carried out under the control of the control-and-processing circuit CPC by means of suitable software. For example, the control-and-processing circuit CPC may send control signals to the optical pickup unit OPU so as to cause said optical pickup unit to carry out a certain step.

In step ST1, the control-and-processing circuit CPC detects that a user has depressed the flash button FB and the image-shot button SB (FB↓ & SB↓). In response to this, the control-and-processing circuit CPC causes the digital camera DCM to carry out the steps described hereinafter (the digital camera DCM may also carry out these steps if the user has depressed the image-shot button SB only and the control-and-processing circuit CPC detects that there is insufficient ambient light).

In step ST2, the optical pickup unit OPU captures a first ambient-light image IM1a at an instant to (OPU: IM1a @ t₀). The control-and-processing circuit CPC stores the first ambient-light image IM1a in the image storage medium ISM (IM1a→ISM). In step ST3, the optical pickup unit OPU captures a second ambient-light image IM2a at an instant to +ΔT (OPU: IM2a @ to +ΔT), with sign ΔT denoting the time interval between the instant when the first ambient-light image IM1a is captured and the instant when the second ambient-light image IM2a is captured. The control-and-processing circuit CPC stores the second ambient-light image IM2a in the image storage medium ISM (IM2a→ISM).

In step ST4, the flash unit FLU produces flashlight (FLSH). The digital camera DCM carries out step ST5 during the flashlight. In step ST5, the optical pickup unit OPU captures a flashlight image IMFa at an instant t₀+2ΔT (OPU: IMFa @ to +2ΔT). Thus, the flashlight occurs just before the instant to +2ΔT. The time interval between the instant when the second ambient-light image IM2a is captured and the instant when the flashlight image IMFa is captured is substantially equal to ΔT. The control-and-processing circuit CPC stores the flashlight image IMFa in the image storage medium ISM (IMFa→ISM).

In step ST6, the control-and-processing circuit CPC carries out a motion estimation on the basis of the first ambient-light image IM1a and the second ambient-light image IM2a, which are stored in the image storage medium ISM (MOTEST[IM1a,IM2a]). One or more objects that form part of these images may be in motion. The motion estimation provides an indication of such motion. The indication typically is in the form of motion vectors (MV).

There are many different manners to carry out the motion estimation in step ST6. A suitable manner is for example the so-called three-dimensional (3D) recursive search, which is described in the article “Progress in motion estimation for video format conversion” by G. de Haan, IEEE Transactions on Consumer Electronics, Vol. 46, No. 3, August 2000, pp. 449-459. An advantage of the 3D recursive search is that this technique generally provides motion vectors that accurately reflect the motion within the image of interest.

In step ST6, it is also possible to carry out a block-matching motion estimation. An image to be encoded is divided into several blocks of pixels. For a block of pixels in the image to be encoded, a block of pixels in a previous or subsequent image is searched that best matches the block of pixels in the image to be encoded. In case of motion, there will be a relative displacement between the two aforementioned blocks of pixels. A motion vector represents the relative displacement. Accordingly, a motion vector can be established for each block of pixels in the image to be encoded.

Either 3D recursive search or block-matching motion estimation can be implemented at relatively low cost. The reason for this is that hardware and software already exist for these types of motion estimation in various consumer-electronics applications. An implementation of the digital camera DCM, which is illustrated in FIG. 1, can therefore benefit from existing low-cost motion-estimation hardware and software. There is no need to develop completely new hardware or software. Although possible, this would be relatively expensive.

In step ST7, the control-and-processing circuit CPC carries out a motion compensation on the basis of the second ambient-light image IM2a and the motion vectors MV that the motion estimation has produced in step ST6 (MOTCMP[IM2a,MV]). The motion compensation provides a motion-compensated ambient-light image IM2a_{MC}, which may be stored in the image storage medium ISM. The motion compensation should compensate for motion between the second ambient-light image IM2a and the flashlight image IMFa. That is, the motion compensation is carried out relative to the flashlight image IMFa.

Ideally, identical objects in the motion-compensated ambient-light image IM2a_{MC} and the flashlight image IMFa have identical positions. That is, all objects should ideally be aligned if the aforementioned images are superposed. The only difference should reside in luminance and color information of the respective objects. The objects in the motion-compensated ambient-light image IM2a_{MC} will appear darker with respect to those in the flashlight image IMFa, which has been captured with flashlight.

In practice, the motion compensation will not perfectly align the images. A relatively small error may remain. This is due to the fact that the motion vectors relate to motion in the second ambient-light image IM2a relative to the first ambient-light image IM1a. That is, the motion vectors do not directly relate to the flashlight image IMFa. Nevertheless, the motion compensation can provide a satisfactory alignment on the basis of these motion vectors.

Alignment will be precise if the motion in the second ambient-light image IM2a relative to the first ambient-light image IM1a, is similar to the motion in the flashlight image IMFa relative to the second ambient-light image IM2a. This will generally be the case if the images are captured in a relatively quick succession. For example, let it be assumed that the images concern a scene that comprises an accelerating object. The object will have a substantially similar speed at respective instants when the images are captured if the time interval is relatively short with respect to the object's acceleration.

In step ST8, which is illustrated in FIG. 2B, the control-and-processing circuit CPC makes a combination of the flashlight image IMFa and the motion-compensated ambient-light image IM2a_{MC} (COMB[IMFa,IM2a_{MC}]). The combination results in an enhanced flashlight image IMFa_{E} in which unnatural and less pleasant effects, which the flashlight may cause, are reduced. For example, color and detail information in the flashlight image IMFa may be combined with light distribution in second ambient-light image IM2a. The color and detail information in the flashlight image IMFa will generally be more vivid than that in the second ambient-light image IM2a. However, the light distribution in the second ambient-light image IM2a will generally be considered more pleasant than that in the flashlight image IMFa. It should be noted that there are various manners to obtain an enhanced image on the basis of an image captured with ambient light and an image captured with flashlight. The article mentioned in the description of the prior art is an example of an image enhancement technique that may be applied in step ST8.

The combination, which is made in step ST8, also offers the possibility to correct for any red eyes that may appear in the flashlight image IMFa. When an image is captured of a living being with eyes and flashlight is used, the eyes may appear red, which is unnatural. Such red eyes may be detected by comparing the motion-compensated ambient-light image IM2a_{MC} with the flashlight image IMFa. Let it be assumed that the control-and-processing circuit CPC detects the presence of red eyes in the flashlight image IMFa. In that case, eye-color information of the motion-compensated ambient-light image IM2a_{MC} defines the color of the eyes in the enhanced flashlight image IMFa. It is also possible that a user detects and corrects red eyes. For example, the user of the digital camera DCM illustrated in FIG. 1 may observe red eyes in the flashlight image IMFa through a display device, which forms part of the user interface UIF. Image processing software may allow the user to make appropriate corrections.

In step ST9, the control-and-processing circuit CPC stores the enhanced flashlight image IMFa_{E} in the image storage medium ISM (IMFa_{E}→ISM). Accordingly, the enhanced flashlight image IMFa_{E} may be transferred to an image display apparatus at a later moment. Optionally, in step ST10, the control-and-processing circuit CPC deletes the ambient-light images IM1a, IM2a and the flashlight image IMFa, which are present in the image storage medium ISM (DEL[IM1a,IM2a,IMFa]). The motion-compensated ambient-light image IM2a_{MC} may also be deleted. However, it may be useful to keep the aforementioned images in the image storage medium ISM so that these can be processed at a later moment.

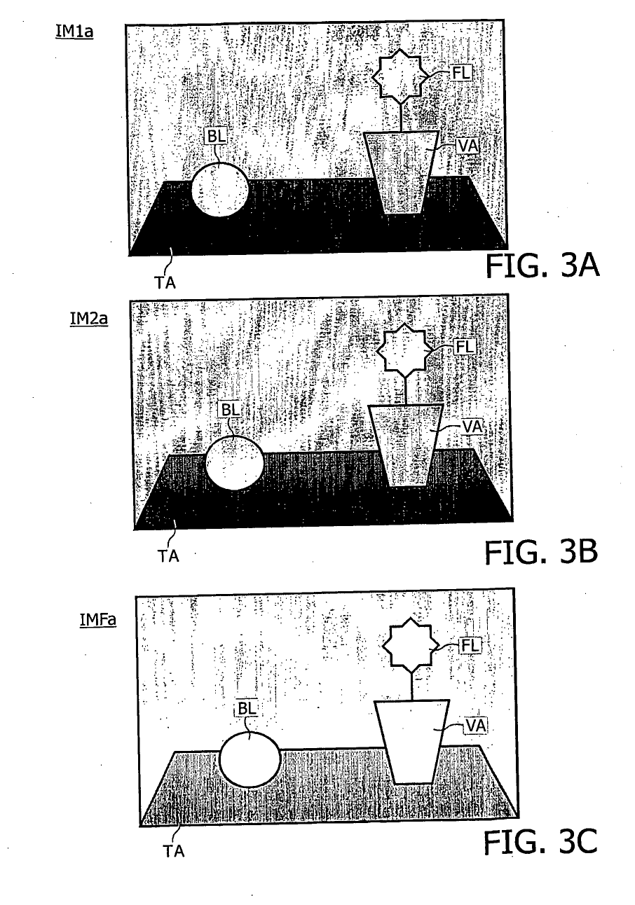

FIGS. 3A, 3B, and 3C illustrate an example of the first and second ambient-light and flashlight images IM1a, IM2a, and IMFa, respectively, which are successively captured as described hereinbefore. In the example, the images concern a scene that comprises various objects: a table TA, a ball BL, and a vase VA with a flower FL. The ball BL moves: it rolls on the table TA towards the vase VA. The other objects are motionless. It is assumed that the person holding the digital camera DCM has a steady hand. The images are captured in relatively quick succession and a rate of, for example, 15 images per second.

Ambient-light images IM1a, IM2a appear to be substantially similar. Both images are taken with ambient light. Each object has similar luminosity and color in both images. The only difference concerns the ball BL, which has moved. Consequently, the motion estimation in step ST6, which has been described hereinbefore, will provide motion vectors that indicate the same. The second ambient-light image IM2a comprises one or more groups of pixels that substantially belong to the ball BL. A motion vector for such a group of pixels indicates the displacement, i.e. the motion, of the ball BL. In contradistinction, a group of pixels that substantially belongs to an object other than the ball BL will have a motion vector that indicates no motion. For example, a group of pixels that substantially belongs to the vase VA will indicate that this is a still object.

The flashlight image IMFa is relatively different from the ambient-light images IM1a, IM2a. In the flashlight image IMFa, foreground objects such as the table TA, the ball BL, the vase VA with the flower FL, are more clearly lit than in the ambient-light images IM1a, IM2a. These objects have a higher luminosity and more vivid colors. The flashlight image IMFa differs from the second ambient-light image IM2a not only because of different light conditions. The motion of the ball BL also causes the flashlight image IFa to be different from the second ambient-light image IM2a. There are thus two main causes that account for differences between the flashlight image IMFa and the second ambient-light image IM2a: light conditions and motion.

The motion vectors, which are derived from the ambient-light images IM1a, IM2a, allow a relatively precise distinction between differences due to light conditions and differences due to motion. This is substantially due to the fact that the ambient-light images IM1a, IM2a have been captured under substantially similar light conditions. The motion vectors are therefore not affected by any differences in light conditions. Consequently, it possible to enhance the flashlight image IMFa on the basis of differences in-light conditions only. The motion compensation, which is based on the motion vectors, prevents that the enhanced flashlight image IMFa_{E} is blurred.

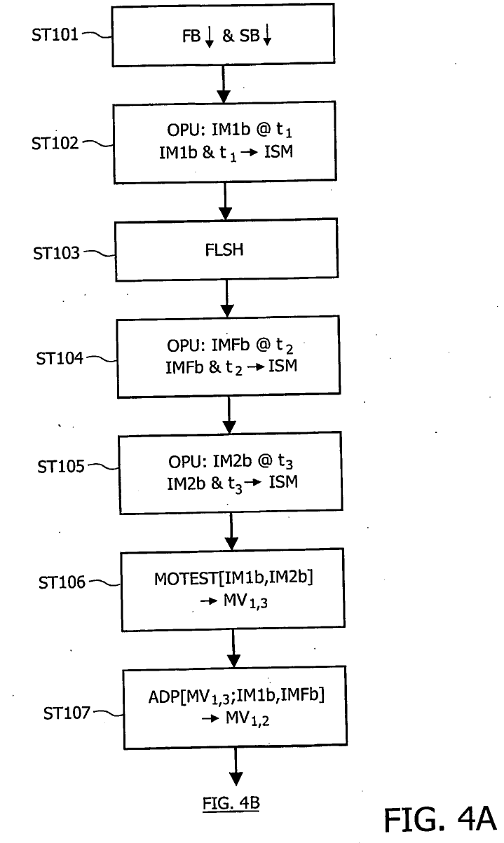

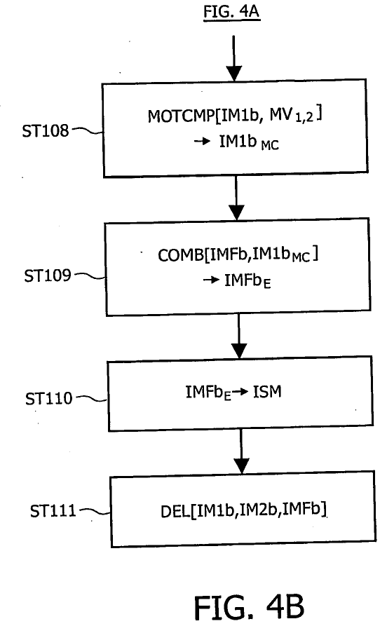

FIGS. 4A and 4B illustrate alternative operations that the digital camera DCM may carry out. The alternative operations are illustrated in the form of a series of steps ST100-ST111. FIG. 4A illustrates steps ST101-ST107 and FIG. 4B illustrates steps ST108-ST111. These alternative operations are typically carried out under the control of the control-and-processing circuit CPC by means of a suitable computer program. FIGS. 4A and 4B thus illustrate alternative software for the control-and-processing circuit CPC.

In step ST101, the control-and-processing circuit CPC detects that a user has depressed the flash button FB and the image-shot button SB (FB↓ & SB↓). In response to this, the control-and-processing circuit CPC causes the digital camera DCM to carry out the steps described hereinafter (the digital camera DCM may also carry out these steps if the user has depressed the image-shot button SB only and the control-and-processing circuit CPC detects that there is insufficient ambient light).

In step ST102, the optical pickup unit OPU captures a first ambient-light image IM1b at an instant t₁ (OPU: IM1b @ t₀). The control-and-processing circuit CPC stores the first ambient-light image IM1b in the image storage medium ISM. A time label that indicates the instant t₁ is stored in association with the first ambient-light image IM1b (IM1b & t₁→ISM).

In step ST103, the flash unit FLU produces flashlight (FLSH). The digital camera DCM carries out step ST104 during the flashlight. In step ST104, the optical pickup unit OPU captures a flashlight image IMFb at an instant t₂ (OPU: IMFb @ t₂). Thus, the flashlight occurs just before the instant t₂. The control-and-processing circuit CPC stores the flashlight image IFb in the image storage medium ISM. A time label that indicates the instant t₂ is stored in association with the flashlight image IMFb (IMFb & t₂→ISM).

The digital camera DCM carries out step ST105 when the flashlight has dimmed and ambient light conditions have returned. In step ST105, the optical pickup unit OPU captures a second ambient-light image IM2b at an instant t₃ (OPU: IM2b @ t₃). The control-and-processing circuit CPC stores the second ambient-light image IM2b in the image storage medium ISM. A time label that indicates the instant t₃ is stored in association with the second ambient-light image IM2b (IM2b & t₃→ISM).

In step ST106, the control-and-processing circuit CPC carries out a motion estimation on the basis of the first ambient-light image IM1b and the second ambient-light image IM2b, which are stored in the image storage medium ISM (MOTEST[IM1b,IM2b]). The motion estimation provides motion vectors MV_{1,3} that indicate motion of objects that form part of the first ambient-light image IM1b and the second ambient-light image IM2b.

In step ST107, the control-and-processing circuit CPC adapts the motion vectors MV_{1,3} that the motion estimation has provided in step ST106 (ADP[MV_{1,3};IM1b,IMFb]). Accordingly, adapted motion vectors MV_{1,2} are obtained. The adapted motion vectors MV_{1,2} relate to motion in the flashlight image IMFb relative to the first ambient-light image IM1b. To that end, the control-and-processing circuit CPC takes into account the respective instants t₁, t₂, and t₃ when the ambient-light and flashlight images IM1b, IM2b, and IMFb have been captured.

The motion vectors MV_{1,3} can be adapted in a relatively simple manner. For example, let it be assumed that a motion vector has a horizontal component and a vertical component. The horizontal component can be scaled with a scaling factor equal to the time interval between instant t₁ and instant t₂ divided by the time interval between instant t₁ and instant t₃. The vertical component can be scaled in the same manner. Accordingly, a scaled horizontal component and a scaled vertical component are obtained. In combination, these scaled components constitute an adapted motion vector, which relates to the motion in the flashlight image IMFb relative to the first ambient-light image IM1b.

In step ST108, which is illustrated in FIG. 4B, the control-and-processing circuit CPC carries out a motion compensation on the basis of the first ambient-light image. IM1b and the adapted motion vectors MV_{1,2} (MOTCMP[IM1b, MV_{1,2}]). The motion compensation provides a motion-compensated ambient-light image IM1b_{MC}, which may be stored in the image storage medium ISM. The motion compensation should compensate for motion between the first ambient-light image IM1b and the flashlight image IMFb. That is, the motion compensation is carried out relative to the flashlight image IMFb.

In step ST109, the control-and-processing circuit CPC makes a combination of the flashlight image IMFb and the motion compensated ambient-light image IM1b_{MC} (COMB[IMFb,IM1b_{MC}]). The combination results in an enhanced flashlight image IMFb_{E} in which unnatural and less pleasant effects, which the flashlight may cause, are reduced. In step ST110, the control-and-processing circuit CPC stores the enhanced flashlight image IMFb_{E} in the image storage medium ISM (IMFb_{E}→ISM). Optionally, in step ST 111, the control-and-processing circuit CPC deletes the ambient-light and flashlight images IM1b, IM2b, IMFb that are present in the image storage medium ISM (DEL[IM1b,IM2b,IMFb]). The motion compensated ambient-light image IM1b_{MC} may also be deleted.

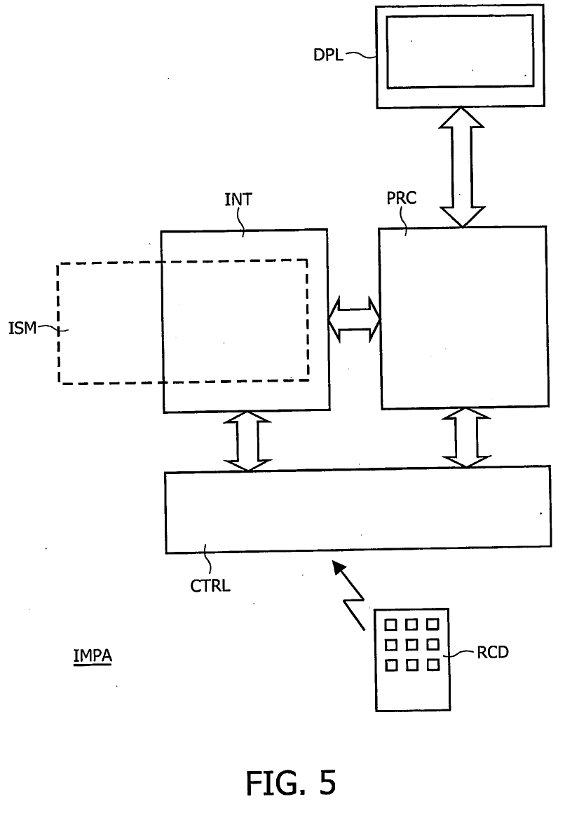

FIG. 5 illustrates an image processing apparatus IMPA that can receive the image storage medium ISM from the digital camera DCM illustrated in FIG. 1. The image processing apparatus IMPA comprises an interface INT, a processor PRC, a display device DPL, and a controller CTRL. The processor PRC comprises suitable hardware and software for processing images stored on the image storage medium ISM. The display device DPL may display an original image or a processed image. The controller CTRL controls operations that various elements, such as the interface MNT, the processor PRC and the display device DPL, carry out. The controller CTRL may interact with a remote-control device RCD via which a user may control these operations.

The image processing apparatus IMPA may process a set of images that relate to a same scene. At least two images have been captured with ambient light. At least one image has been captured with flashlight. FIGS. 3A, 3B, and 3C illustrate such a set of images. The image processing apparatus IMPA carries out a motion estimation on the basis of the at least two images captured with ambient light. Accordingly, a motion indication is obtained, which may be in the form of motion vectors. Subsequently, this motion indication is used to enhance an image captured with flashlight on the basis of at least one image that is taken with ambient light.

For example, let it be assumed that the digital camera DCM is programmed to carry out steps ST1-ST5, but not step ST10 (see FIGS. 2A and 2B). The image storage medium ISM will comprise the ambient-light images IM1a, IM2a and the flashlight image IMFa. The image processing apparatus IMPA illustrated in FIG. 5 may carry out steps ST6-ST8, which are illustrated in FIGS. 2A and 2B, so as to obtain the enhanced flashlight image IMFb_{E}. This process may be user-controlled in a manner similar to conventional photo editing on a personal computer. For example, the user may define the extent to which lighting distribution in the enhanced flashlight image IMFb_{E} is based on lighting distribution in the second ambient-light image IM2a.

Alternatively, the digital camera DCM may be programmed to carry out steps ST101-ST105, but not step ST111 (see FIGS. 4A and 4B). The image processing apparatus IMPA illustrated in FIG. 5 may then carry out steps ST106-ST109, which are illustrated in FIGS. 4A and 4B, so as to obtain the enhanced flashlight image IMFb_{E}.

The enhanced flashlight image will have a quality that substantially depends on motion-estimation precision. As mentioned hereinbefore, 3D-recursive search allows relatively good precision. A technique known as Content Adaptive Recursive Search is a good alternative. Complex motion estimation techniques may be used that can account for tilt as well as translation between images. Furthermore, it is possible to first carry out a global motion estimation, which relates to an image as a whole, and, subsequently, a local motion estimation, which relates to various different parts of the image. Sub-sampling the image simplifies the global motion estimation. It should also be noted that the motion estimation can be segment-based instead of block-based. A segment-based motion estimation takes into account that an object may have a form that is quite different from that of a block. A motion vector may relate to an arbitrary-shaped group of pixels, not necessarily a block. Accordingly, a segment-based motion estimation can be relatively precise.

The following rule generally applies. The greater the number of images on which the motion estimation is based, the more precise the motion estimation will be. In the description hereinbefore, the motion estimation was based on two images captured with ambient light. A more precise motion estimation can be obtained if more than two images are captured with ambient light and subsequently used for estimating motion. For example, it is possible to estimate the speed of an object on the basis of two images that have been successively captured, but not the acceleration of the object. Three images allow acceleration estimation. Let it be assumed that three ambient-light images are captured in association with a flashlight image. In that case, a more precise estimation can be made of where objects will be at the instant when the flashlight image is captured compared with when two ambient light images are captured.

### CONCLUDING REMARKS

The detailed description hereinbefore with reference to the drawings illustrates the following characteristics. A set of images that have successively been captured comprises a plurality of images that have been captured under substantially similar light conditions (first and second ambient-light images IM1a, IM2a, FIG. 2A, and IM1b, IM2b, FIG. 4A) and an image that has been captured under substantially different light conditions (flashlight image IMFa, FIG. 2A, and IMFb, FIG. 4A). A motion indication (in the form of motion vectors MV) is derived from at least two images that have been captured under substantially similar light conditions (this is done in step ST6, FIG. 2A and in steps ST106, ST107, FIG. 4A). The image that has been captured under substantially different light conditions is processed on the basis of the motion indication derived from the at least two images that have been captured under substantially similar light conditions (this is done in steps ST7, ST8, FIGS. 2A, 2B, and in steps ST108, ST109, FIG. 4B; the enhanced flashlight image IMFa_{E} results from this processing).

The detailed description hereinbefore further illustrates the following optional characteristics. At least two images are first captured with ambient light and, subsequently, an image is captured with flashlight (operation in accordance with FIGS. 2A and 2B: the two ambient-light images IM1a, IM2a are first captured and, subsequently, the flash light image IMFa). An advantage of these characteristics is that the ambient-light images, on which the motion estimation is based, can be captured relatively shortly before the flashlight image is captured. This contributes to the precision of the motion-estimation and, therefore, to a good image quality.

The detailed description hereinbefore further illustrates the following optional characteristics. The images are successively captured at respective instants with a fixed time interval (ΔT) between these instants (operation in accordance with FIGS. 2A and 2B). An advantage of these characteristics is that motion estimation and further processing can be relatively simple. For example, motion vectors, which are derived from the ambient-light images, can directly be applied to the flash light image. No adaptation is required.

The detailed description hereinbefore further illustrates the following optional characteristics. An image is captured with ambient light, subsequently, an image is captured with flashlight, and subsequently, a further image is captured with ambient light (operation in accordance with FIGS. 4A and 4B: flashlight image IMFb is in between the ambient-light images IM1b, IM2b). An advantage of these characteristics is that motion estimation can be relatively precise, in particular in case of constant-speed motion. Since the flashlight image is sandwiched, as it were, between the ambient-light images, respective positions of objects in the flashlight image can be estimated with relatively great precision.

The detailed description hereinbefore further illustrates the following optional characteristics. The motion indication comprises an adapted motion vector (MV_{1,2}) which is obtained as follows (FIGS. 4A and 4B illustrate this). A motion vector (MV_{1,3}) is derived from at least two images that have been captured under substantially similar light conditions (step ST106: MV_{1,3} is derived from the ambient-light images IM1b, IM2b). The motion vector is adapted on the basis of respective instants (t₁, t₂, t₃) when the at least two images have been captured and when the image (1 Mb) has been captured under substantially different light conditions (step ST107). This further contributes to motion-estimation accuracy.

The detailed description hereinbefore further illustrates the following optional characteristics. The motion-estimation step establishes a motion vector that belongs to a group of pixels in a manner that takes into account a motion vector that has been established for another group of pixels. This is the case, for example, in 3D recursive search. The aforementioned characteristic allows accurate motion estimation compared with simple block-matching motion estimation techniques. Motion vectors will truly indicate motion of an object to which the relevant group of pixels belongs. This contributes to a good image quality.

The aforementioned characteristics can be implemented in numerous different manners. In order to illustrate this, some alternatives are briefly indicated. The set of images may form a motion picture instead of a still picture. For example, the set of images to be processed may be captured by means of a camcorder. The set of images may also result from a digital scan of a set of conventional paper photos. The set of images may comprise more than two images that have been captured under substantially similar light conditions. The set may also comprise more than one image that has been captured under substantially different light conditions. The images may be located anywhere with respect to each other. For example, a flashlight image may have been captured first followed by two ambient-light images. A motion indication may be derived from the two ambient-light images, on the basis of which the flashlight image can be processed. Alternatively, two flashlight images may have been captured first and, subsequently, an ambient-light image. A motion indication is derived from the flashlight images. In this case, the flashlight images constitute the images that have been taken under substantially similar light conditions.

There are numerous different manners to process the set of images. Processing need not necessarily include image enhancement as described hereinbefore. The processing may include, for example, image encoding. In case the processing includes image enhancement, there are many ways to do so. In the description hereinbefore, a motion-compensated ambient-light image is first established. Subsequently, a flashlight image is enhanced on the basis of the motion-compensated ambient-light image. Alternatively, the flashlight image may directly be enhanced on a block-by-block basis. A block of pixels in the flashlight image may be enhanced on the basis of a motion vector for that block of pixels, which indicates a corresponding block of pixels in an ambient-light image. Accordingly, respective blocks of pixels in the flashlight image may be successively enhanced. In such an implementation, there is no need to first establish a motion-compensated ambient-light image.

The set of images need not necessarily comprise time labels that indicate respective instants when respective images have been captured. Time labels are not required, for example, if there are fixed time intervals between these respective instants. Time intervals need not be identical, it is sufficient that they are known.

There are numerous ways of implementing functions by means of items of hardware or software, or both. In this respect, the drawings are very diagrammatic, each representing only one possible embodiment of the invention. Moreover, although a drawing shows different functions as different blocks, this by no means excludes that a single item of hardware or software carries out several functions or that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of processing a set of images (IM1a, IM2a, IMFa; IM1b, IM2b, IMFb) that have been successively captured, the set comprising a plurality of images (IM1a, IM2a; IM1b, IM2b) that have been captured under substantially similar light conditions, and an image (IMFa; IMFb) that has been captured under substantially different light conditions (FLSH), the method comprising:
a motion-estimation step (ST6; ST106, ST107) in which a motion indication (MV) is derived from at least two images that have been captured under substantially similar light conditions; and
a processing step (ST7, ST8; ST108, ST109) in which the image that has been captured under substantially different light conditions is processed on the basis of the motion indication derived from the at least two images that have been captured under substantially similar light conditions.

2. A method of processing as claimed in claim 1, comprising:
an image capturing step wherein at least two images (IM1a, IM2a) are captured with ambient light and, subsequently, an image (IMFa) is captured with flashlight.

3. A method of processing as claimed in claim 2, wherein the images (IM1a, IM2a, IMFa) are successively captured at respective instants with a fixed time interval (ΔT) between these instants.

4. A method of processing as claimed in claim 1, comprising:
an image capturing step wherein an image (IM1b) is captured with ambient light, subsequently, an image (IMFb) is captured with flashlight, and subsequently, a further image (IM2b) is captured with ambient light.

5. A method of processing as claimed in claim 1, wherein the motion indication comprises an adapted motion vector (MV_{1,2}), which results from:
a motion-vector derivation step (ST106) in which a motion vector (MV_{1,3}) is derived from at least two images (IM1b, IM2b) that have been captured under substantially similar light conditions; and
a motion-vector adaptation step (ST107) in which the motion vector is adapted on the basis of respective instants (t₁, t₂, t₃) when the at least two images have been captured and when the image (IMFb) has been captured under substantially different light conditions.

6. A method of processing as claimed in claim 1, wherein the set of images comprises more than two images that have been captured under similar light conditions and wherein the motion indication is derived from these more than two images.

7. A method of processing as claimed in claim 1, wherein the motion-estimation step (ST6; ST106, ST107) establishes a motion vector that belongs to a group of pixels in a manner that takes into account a motion vector that has been established for another group of pixels.

8. An image processor (IMPA) arranged to process a set of images (IM1a, IM2a, IMFa; IM1b, IM2b, IMFb) that have been successively captured, the set comprising a plurality of images (IM1a, IM2a; IM1b, IM2b) that have been captured under substantially similar light conditions, and an image (IMFa; IMFb) that has been captured under substantially different light conditions (FLSH), the image processor comprising:
a motion estimator (MOTEST) arranged to derive a motion indication (MV) from at least two images that have been captured under substantially similar light conditions; and
an image processor (PRC) arranged to process the image that has been captured under substantially different light conditions on the basis of the motion indication derived from the at least two images that have been captured under substantially similar light conditions.

9. An image capturing apparatus (DCM) comprising:
an image capturing arrangement (OPU, FLU, CPC, UIF) arranged to successively capture a set of images (IM1a, IM2a, IMFa; IM1b, IM2b, IMFb) that comprises a plurality of images (IM1a, IM2a; IM1b, IM2b) that have been captured under substantially similar light conditions, and an image (IMFa; IMFb) that has been captured under substantially different light conditions (FLSH);
a motion estimator (MOTEST) arranged to derive a motion indication (MV) from at least two images that have been captured under substantially similar light conditions; and
an image processor (PRC) arranged to make a combination of the image that has been captured under substantially different light conditions and at least one of the images that have been captured under substantially similar light conditions so as to obtain an improved image (IMF_{E}), the combination being made on the basis of the motion indication derived from the at least two images that have been captured under substantially similar light conditions.

10. A computer program product for an image processor (IMPA) arranged to process a set of images (IM1a, IM2a, IMFa; IM1b, IM2b, IMFb) that have been successively captured, the set comprising a plurality of images (IM1a, IM2a; IM1b, IM2b) that have been captured under substantially similar light conditions, and an image (IMFa; IMFb) that has been captured under substantially different light conditions (FLSH), the computer program product comprising a set of instructions that, when loaded into the image processor, causes the image processor to carry out:
a motion-estimation step (ST6; ST106, ST107) in which a motion indication (MV) is derived from at least two images that have been captured under substantially similar light conditions; and
a processing step (ST7, ST8; ST108, ST109) in which the image that has been captured under substantially different light conditions is processed on the basis of the motion indication derived from the at least two images that have been captured under substantially similar light conditions.
